(19) United States
(12) Patent Application Publication
(10) Pub. No.: US 2012/0088468 A1
(43) Pub. Date: Apr. 12, 2012

(54) Emergency 911 wireless call detector

(76) Inventors: Richard Dickinson, Seattle, WA (US); Firdaus Aryana, Seattle, WA (US)

(21) Appl. No.: 13/317,173

(22) Filed: Oct. 12, 2011

Related U.S. Application Data
(60) Provisional application No. 61/344,799, filed on Oct. 12, 2010.

(51) Int. Cl. H04W 4/04

(52) U.S. Cl. 455/404.2

(57) ABSTRACT

An accurate building-specific location for a mobile device requesting Enhanced 911 (E911) emergency services is provided while located indoors. A central server and associated plurality of emergency 911 wireless call detectors are programmed with Master Street Address Guide (MSAG) information, and installed throughout the walls of a given building to provide comprehensive E911 coverage. The building-specific information includes room number, floor number, column number, and/or other building information regarding the relevant detector's location in a corresponding building, and thus an accurate position of the calling mobile device within a given building.

### BACKGROUND OF THE INVENTION

1. Field of the Invention

This invention relates generally to wireless telecommunications. More particularly, it relates to E911 location services and text messaging to 911 services in the wireless industry.

2. Background of the Related Art

Enhanced 911 (E911) is an emergency service provided to the public. A modern representation of the Basic 911 service, namely Enhanced 911 (E911), is capable of detecting a telephone number from which a 911 caller is calling and subsequently cross-referencing the calling device's detected number (TN) against 911 databases to determine the registered address associated with a caller's landline telephone. Based on a caller's registered location, E911 is able to route a 911 call to an appropriate Public Safety Access Point (PSAP) responsible for dispersing emergency services in a calling device's noted jurisdiction.

A vast increase in the use of wireless telecommunications services and the continuously growing shift from landline communications to mobile communications has led to a rising demand in the reform of E911 emergency services. The Federal Communications Commission (FCC) mandated that wireless service providers extend present E911 services to provide Wireless E911 support to all wireless telecommunication devices. The Federal Communications Commission's (FCC's) E911 mandate states wireless service providers must be capable of providing cell phone location of a 911 caller to an associated Public Safety Access Point (PSAP) responsible for a calling device's location, within a percentage of accuracy spelled out in the Federal Communications Commission's (FCC's) strict Wireless E911 Location Accuracy Requirements.

FIG. 4 shows conventional call flow of a 911 call through a Wireless E911 Network.

In particular, as shown in FIG. 4, in a traditional Wireless E911 network, a Wireless E911 call is initiated when a user dials 911 from a wireless device 101. A nearby cell site 102 detects that a call has been made and communicates with a wireless carrier's Mobile Switching Center (MSC) 103.

The Public Safety Access Point (PSAP) 108 receives E911 calls originating from a range of call locations within an assigned jurisdiction of the Public Safety Access Point (PSAP) 108. The 911 caller's telephone number (TN) and current location data are provided to the Public Safety Access Point (PSAP) 108 so that the Public Safety Access Point (PSAP) 108 may alert and dispatch proper emergency response agencies.

A Mobile Switching Center (MSC) 103 manages call switching and routing in a wireless network and provides data required to support a wireless carrier's mobile service subscribers, e.g., billing and authorization information. The Mobile Switching Center (MSC) 103 is able to recognize that an E911 call has been placed and consequently references an Automatic Number Identification system (ANI) to determine the telephone number (TN) associated with the subscriber that has initiated an E911 call. The Mobile Switching Center (MSC) 103 queries a Mobile Positioning Center (MPC) 104 for call routing instructions, preferably provisioning the Mobile Positioning Center (MPC) 104 with the cell site an E911 call has originated from and the call back number (CBN) for the wireless device that has placed an E911 call.

A Mobile Positioning Center (MPC) 104 in a traditional Wireless E911 system, utilizes information received on a network, e.g., location requests to a Position Determining Entity (PDE) 105, to locate the position of a mobile terminal. The Position Determining Entity (PDE) 105 provides a Mobile Positioning Center (MPC) 104 with location coordinates required to satisfy Phase II of the Federal Communications Commission's (FCC's) E911 mandate, which states a call back number (CBN) and precise location coordinates must be provided to a Public Safety Answering Point (PSAP) 108 in the event of a Wireless E911 call. Position Determining Entities (PDEs) 105 are based on location tracking technologies that may be network-based, device-based, or a combination of the two.

Location information acquired by the Mobile Positioning Center (MPC) 104 in a Wireless E911 system is inserted into an E911 database, particularly the Automatic Location Information (ALI) 109 database, for later retrieval by the Public Safety Access Point (PSAP) 108.

The Mobile Positioning Center (MPC) 104 is responsible for relaying routing instructions for an E911 call to the wireless carrier's Mobile Switching Center (MSC) 103. Once the Mobile Positioning Center (MPC) 104 is queried by the Mobile Switching Center (MSC) 103, the Mobile Positioning Center (MPC) 104 proceeds to query a Coordinate Routing Database (CRDB) 106, providing the Coordinate Routing Database (CRDB) 106 with the cell site the E911 call has originated from. The Coordinate Routing Database (CRDB) 106 includes information pertaining to Public Safety Access Points (PSAPs) 108 responsible for serving particular cell tower locations and indicates to the Mobile Positioning Center (MPC) 104 which Public Safety Access Point (PSAP) 108 is responsible for dispatching emergency services to the proper Public Safety Access Point (PSAP) 108, based on location coordinates determined by the Position Determining Entity (PPE) 105.

The Mobile Positioning Center (MPC) 104 returns routing instructions to a Mobile Switching Center (MSC) 103 in the form of a pseudo-Automatic Number Identification (pANI). A pseudo-Automatic Number Identification (pANI) is a ten-digit number that identifies a specific trunk group to use between the relevant Mobile Switching Center (MSC) 103 and a Selective Router (SR) 107.

The Mobile Switching Center (MSC) 103 directs an E911 call to the Selective Router (SR) 107 based on the contents of a pseudo-Automatic Number Identification (pANI), returned to the Mobile Switching Center (MSC) 103 by the Mobile Positioning Center (MPC) 104 in a Wireless E911 call flow. The Selective Router (SR) 107 is dedicated to emergency service calls so as not to interfere with normal telephone traffic. The Selective Router (SR) 107 routes the E911 voice call, along with the assigned pseudo-Automatic Number Identification (pANI), to the appropriate Public Safety Access Point (PSAP) 108.

The Automatic Location Information (ALI) 109 database, in a Wireless E911 system, is the wireless carriers' subscriber location database. Addresses associated with subscribers are stored in the Automatic Location Information (ALI) 109 database, and may be identified by searching the database for a subscriber's assigned mobile telephone number (TN) or for a pseudo-Automatic Number Identification (pANI) assigned to a particular E911 call.

The Public Safety Access Point (PSAP) 108 queries an Automatic Location Identification (ALI) 109 database for the location of the calling device 101, supplying the Automatic Location Information (ALI) 109 database query with a pseudo-Automatic Number Identification (pANI). The Automatic Location Identification (ALI) 109 database routes the Public Safety Access Point's (PSAP's) 108 location query to the Mobile Positioning Center (MPC) 104 that issued the pseudo-Automatic Number Identification (pANI). Location information is then returned to the Automatic Location Information (ALI) 109 database and relayed to the Public Safety Access Point (PSAP) 108 for dispensing of proper emergency services.

Although many advances have been made towards achieving Wireless E911 , it is still difficult to provide accurate location data for cell phones located within buildings, which can and often do have multiple floors, apartments, offices, etc. The Federal Communications Commission (FCC) currently enforces outdoor location accuracy requirements pertaining to E911 location detection. The lack of indoor location accuracy requirements derives largely from the fact that a Global Positioning System (GPS), a location tracking device present in most wireless telecommunications devices today, is unequipped to receive signals from satellites, required for calculating position, when GPS is used inside buildings. Another important factor contributing to the lack of effective location determination of a wireless telecommunication device used indoors is the fact that even if a Position Determining Entity (PDE) is capable of determining latitude and longitude coordinates for a building in which an E911 call is made, coordinates often still fail to pinpoint the exact location within a larger building, e.g., floor and room number, the calling cellular device is located. Depending upon the size of a building that the 911 call is received from, precise location information may be essential for the speedy distribution of requested emergency services.

### SUMMARY OF THE INVENTION

An emergency wireless call detector in accordance with the principles of the present invention comprises a mobile phone sniffer module to detect an active emergency 911 call within a proximity of the emergency wireless call detector. A programmable local location information module stores building-specific local location information relating to a physical location within a given building of an antenna of the emergency wireless call detector.

In accordance with another aspect of the invention, an emergency wireless call detector network comprises a plurality of emergency wireless call detectors for mounting on separate floors of a given building. A local 911 call server included a physical communication interface with the plurality of emergency wireless call detectors. A physical Internet Protocol (IP) interface in the local 911 call server permits IP communication between the local 911 call server and a network-based 911 call server. The local 911 call server communicates building-specific location information from at least one of the plurality of emergency wireless call detectors to the network-based 911 call server.

A method of obtaining building-specific location information about a location of a calling wireless device within a given building in accordance with another aspect of the invention comprises receiving an emergency 911 call. Building-specific location information from a detecting emergency 911 wireless call detector located within a building from which the emergency 911 call was initiated, is matched with a wireless device making the emergency 911 call.

### BRIEF DESCRIPTION OF THE DRAWINGS

Features and advantages of the present invention will become apparent to those skilled in the art from the following description with reference to the drawings, in which:

FIG. 1 shows a multi-story building including a plurality of emergency 911 wireless call detectors, in accordance with the principles of the present invention.

FIG. 2 shows exemplary functional modules of an emergency 911 wireless call detector, in accordance with the principles of the present invention.

FIG. 3 shows exemplary call flow through a network including emergency 911 wireless call detectors, in accordance with the principles of the present invention.

FIG. 4 shows conventional call flow of a 911 call through a wireless E911 network.

### DETAILED DESCRIPTION OF ILLUSTRATIVE EMBODIMENTS

The present invention provides a method of, and apparatus for, determining an accurate location for a mobile device requesting Enhanced 911 (E911 ) emergency services while located indoors. A central server and associated plurality of emergency 911 wireless call detectors are programmed with Master Street Address Guide (MSAG) information. The plurality of emergency 911 wireless call detectors are installed throughout the walls of a given building to provide comprehensive E911 coverage. The Master Street Address Guide (MSAG) addresses, programmed into the emergency 911 wireless call detectors or server, contain coordinates or other specific location information regarding the relevant detector's location in a corresponding building, e.g., the floor and room number that the given emergency 911 wireless call detector is located in.

The present inventors have appreciated that currently, there remains no ubiquitous solution for providing cellular location of devices located within buildings. Moreover, the current inventors also appreciated that current location accuracy requirements are placed exclusively on wireless carriers whom maintain no authoritative privileges to modify buildings within which their customers make calls, nor would it be practically conceivable for each individual carrier to make such building modifications.

In accordance with the principles of the present invention, emergency 911 wireless call detectors capable of sensing 911 calls are built into buildings having an ability to provide specific location of the room, floor number, etc. of a building from which a given emergency 911 call is placed, without the need to exploit present tracking technologies.

The present invention further provides a method and apparatus for determining the precise location of a mobile device requesting Enhanced 911 (E911 ) emergency services while located indoors. The embodiments disclosed herein provide a wireless E911 network that includes a central server and a plurality of emergency 911 wireless call detectors programmed with Master

Street Address Guide (MSAG) valid addresses and installed throughout the walls of a given building.

Current location information comprising latitude/longitude (lat/lon) information, even when accurate, does not include floor or height data. The present invention introduces the capability to provide such data.

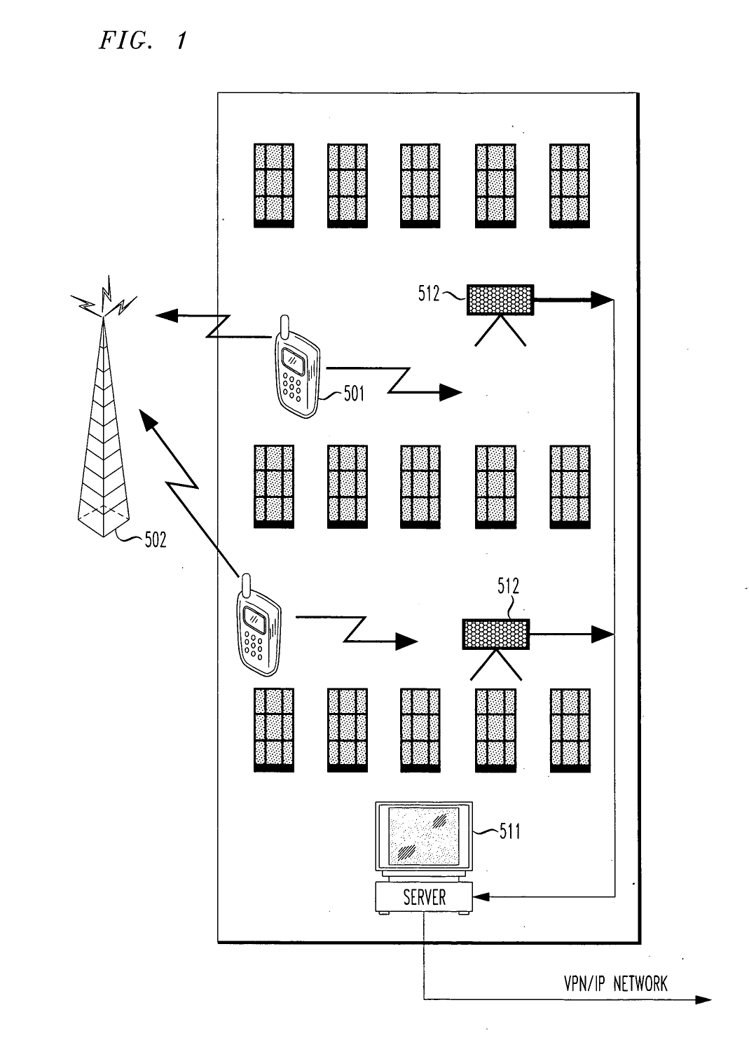

FIG. 1 shows a multi-story building including a plurality of emergency 911 wireless call detectors, in accordance with the principles of the present invention.

In particular, as shown in FIG. 1, a plurality of emergency 911wireless call detectors 512 are installed throughout each floor of a relevant building, e.g., in each hallway, or room, etc. In one embodiment the plurality of emergency 911 wireless call detectors 512 are each installed in conjunction with a corresponding smoke detector.

To enable location detection of E911 caller's wireless calling devices 501 used within buildings, the emergency 911 wireless call detectors 512 within a building are connected, e.g., via cable or wirelessly, to a local 911 call server 511, which may also be located within the building.

In the disclosed embodiments, each emergency 911 wireless call detector 512 is locally programmed to contain specific identification information, e.g., using a USB interface and a computer, with the floor number, room number, and Master Street Address Guide (MSAG) address of the building that the specific emergency 911 wireless call detector 512 is located in.

The local 911 call server 511 preferably maintains a database correlating each emergency 911 wireless call detector 512 within its responsibilities, e.g., within that building, with that emergency 911 wireless call detector's 512 associated location information; e.g., with floor number, room number, and Street Addressing Guide (MSAG) address. The local 911 call server 511 is in communication with the wireless carrier's Mobile Positioning Center (MPC) 504, e.g., via Virtual Private Network (VPN) or the Internet.

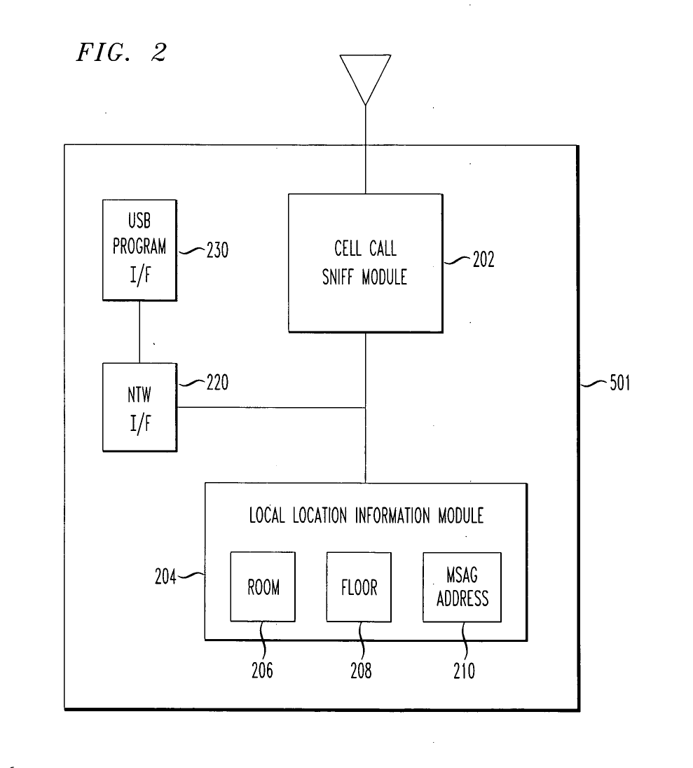

FIG. 2 shows exemplary functional modules of an emergency 911 wireless call detector, in accordance with the principles of the present invention.

In particular, as shown in FIG. 2, an emergency 911 wireless call detector 501 comprises a mobile phone sniffer module 202, a customer-programmable local location information module 204 comprising non-volatile room number 206, floor 208, and MSAG address 210, a network interface module 220, and a program interface such as a Universal Serial Bus (USB) interface 230 permitting a customer to self-program the data stored in the local location information module 204. (Alternatively, the data stored in the local location information module 204 may be programmed via the network interface 220 from a remote source, e.g., via the local 911 call server 511.

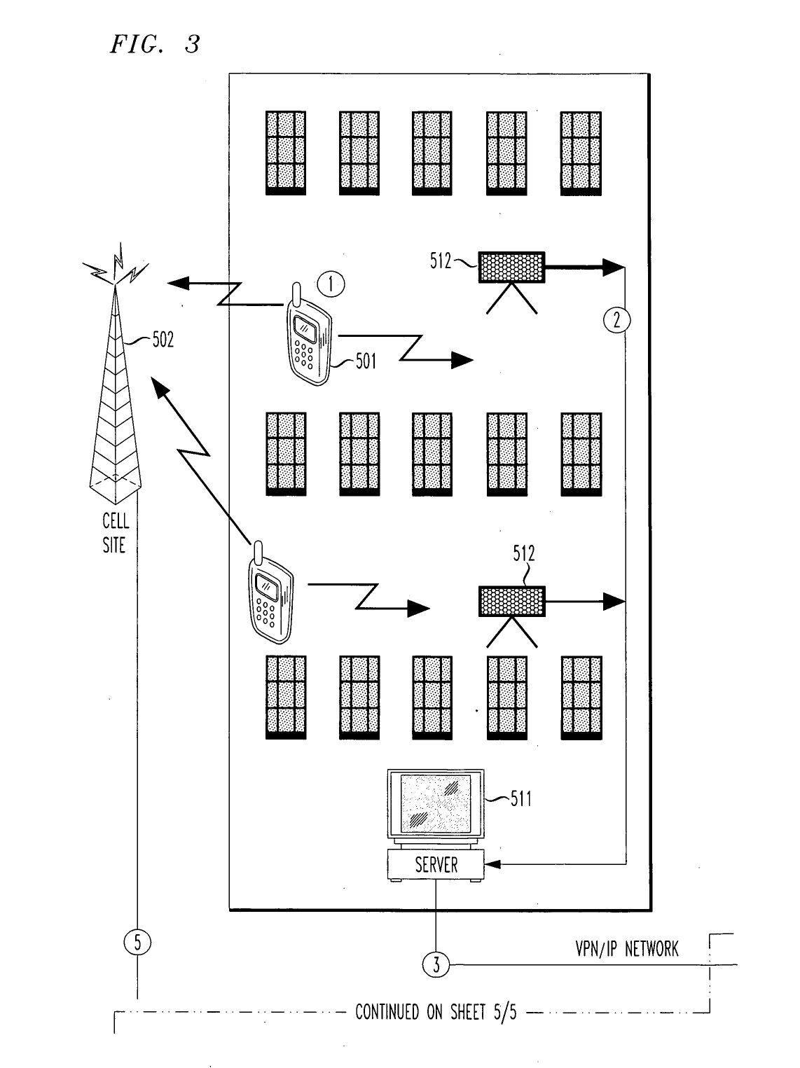

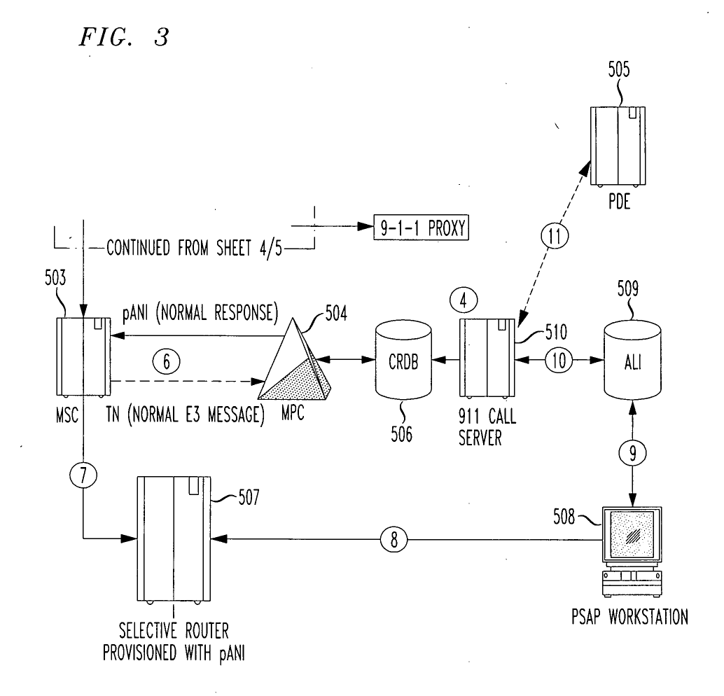

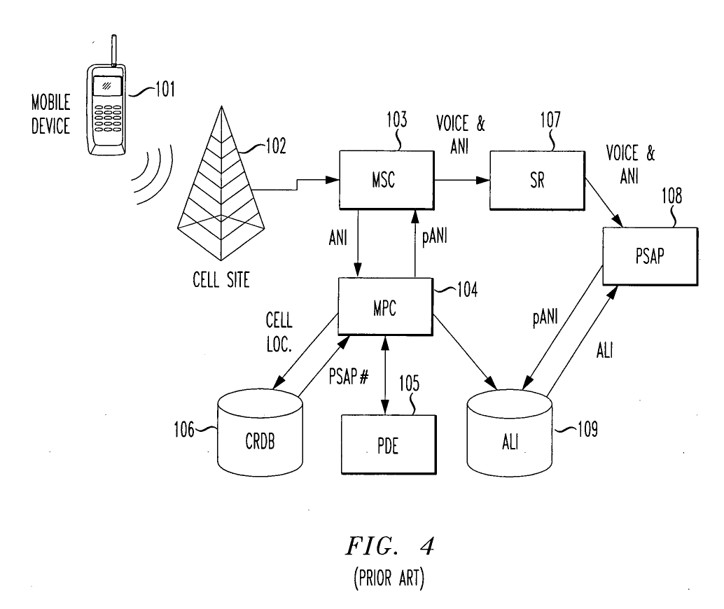

FIG. 3 shows exemplary call flow through a network including emergency 911 wireless call detectors, in accordance with the principles of the present invention.

In particular, as shown in FIG. 3, in accordance with the principles of the present invention, once a mobile device 501 initiates an emergency 911 call, an emergency 911 wireless call detector within nearest proximity to the calling mobile device 501 immediately detects that an emergency 911 call has been made and contacts a central E911 Call Server 510 associated with the corresponding building. When alerted, the E911 Call Server 510 associated with a given building and preferably located within the relevant building contacts a Mobile Positioning Center (MPC) 504 within a wireless network, and stages the 911 calling device's Telephone Number (TN) and Master Street Address Guide (MSAG) valid address (preferably stored with the alerted emergency 911 wireless call detector) in an Automatic Location Information (ALI) 509 database, used to store location information associated with Mobile Device Numbers (MDNs). The emergency 911 call continues to progress normally throughout the E911 network as pertaining to otherwise conventional technology.

In accordance with another aspect of the present invention, once the Mobile Positioning Center (MPC) 504 is routinely informed of an emergency 911 call and queried for location information, the Mobile Positioning Center (MPC) 504 foregoes traditional Position Determining Entity (PDE) 505 queries and instead cross-references the Telephone Number (TN) it has received in a location query for a mobile device, with the Telephone Number (TN) and Master Street Address Guide (MSAG) address provided by a building emergency 911 wireless call detector for that device and staged in the Automatic Location Information (ALI) 509 database. The Mobile Positioning Center (MPC) 504 then forwards the queried telephone number (TN) and associated Master Street Address Guide (MSAG) address to a Public Safety Access Point (PSAP) 508 via otherwise routine existing procedures and equipment.

The present invention further provides a method and apparatus for processing an emergency E911 call, while foregoing traditional location determination technologies of a wireless device, e.g., handset-based and/or network-based tracking technologies, instead providing Public Safety Access Points (PSAPs) 508 with superior location information, incorporating the position coordinates of a building, as well as floor and room number pertaining to an E911 call placed indoors.

In step 1 shown in FIG. 3, a wireless caller initiates an emergency 911 call by dialing “9-1-1” from a wireless device 501 located within a multistory building. The emergency E911 call is substantially simultaneously detected by both the local emergency 911 wireless call detector 512 within closest proximity to the placed call, and the wireless carrier's serving base station 502.

In step 2, the 911 call begins routine call routing procedures via the wireless carrier's legacy cellular network, per existing equipment and technology. Concurrently, the specific emergency 911 wireless call detector 512 that detects the E911 call sniffs the calling wireless device's 501 telephone number (TN). The emergency 911 wireless call detector 512 alerts its local 911 call server 511 within the building that an E911 call has been made, and supplies the network 911 Call Server 510 with the telephone number (TN) of the wireless device 501 that has placed the emergency 911 call.

In step 3, the network 911 Call Server 510 alerts the Mobile Positioning Center (MPC) 504, e.g., via Virtual Private Network (VPN) or Internet, of the E911 call, and supplies the Mobile Positioning Center (MPC) 504 with appropriate building specific location information programmed either into the emergency 911 wireless call detectors 512 themselves, or into the local 911 call server 511; e.g., the floor name or number, room name or number, and Master Street Address Guide (MSAG) address associated with the alerted emergency 911 wireless call detector 512, as well as the detected telephone number (TN) of the calling party 501.

In step 4, the Mobile Positioning Center (MPC) 504 receives the phone number (MIN, etc.) of the 911 calling device 501 from a routine location query from the Mobile Switching Center (MSC) 503, and matches the phone number of the 911 calling device 501 with the phone number obtained from the alerted emergency 911 wireless call detector 512. If the two phone numbers match, the Mobile Positioning Center (MPC) 504 stages the location information (e.g., floor number, room number, and Master Street Address Guide (MSAG) address), received from the emergency 911 wireless call detector 512 in the Automatic Location Information (ALI) 509 database, for later retrieval by a Public Service Access Point (PSAP) 508. If the two phone numbers do not match, the Mobile Positioning Center (MPC) 504 queries a legacy Position Determining Entity (PDE) 505, per existing technology.

Steps 5-9 otherwise demonstrate routing of an emergency E911 wireless call per existing technology. In particular, in steps 5 and 6, the Mobile Switching Center (MSC) 503 queries a Mobile Positioning Center (MPC) 504 for routing instructions, supplying the Mobile Positioning Center (MPC) 504 with an appropriate Automatic Number Identification (ANI).

In step 7, the Mobile Positioning Center (MPC) 504 responds to the Mobile Switching Center's (MSC's) 503 query with a corresponding pseudo-Automatic Number Identification (pANI). In accordance with the present invention, a Mobile Positioning Center (MPC) 504 can alternatively respond to a Mobile Switching Center's (MSC's) 503 query for routing instructions with an Emergency Service Number (ESN) associated with the Master Street Address Guide (MSAG) address provided to the Mobile Positioning Center (MPC) 504 by the 911 call server 510.

In steps 8-10, based on the pseudo-Automatic Number Identification (pANI) obtained, the Mobile Switching Center (MPC) 504 routes the emergency E911 voice call to a selective router (SR) 507. The selective router (SR) 507 continues to route the emergency E911 voice call to the appropriate

Public Safety Access Point (PSAP) 508, which proceeds to query the Automatic Location Identification (ALI) 509 database, per existing procedures, using the pseudo-Automatic Number Identification (pANI).

In step 11, in accordance with the present invention, the Automatic Location Identification (ALI) 509 database steers the location query it obtains pertaining to the pseudo-Automatic Number Identification (pANI) associated with the placed emergency E911 call, from the Public Safety Access Point (PSAP) 508, to the Mobile Positioning Center (MPC) 504. The Mobile Positioning Center (MPC) 504 responds to the location query with the staged location record for the associated phone number, including the floor number, room number, and Master Street Address Guide (MSAG) address provided by the alerted emergency 911 wireless call detector 512. Location information is then routed back to the Public Safety Access Point (PSAP) 508 for use in emergency service distribution.

In the disclosed embodiments there is no latitude/longitude (lat/lon) provided, but rather descriptive location information particular to the given locale is, e.g., room number, floor number, etc.

In step 12, the Mobile Positioning Center (MPC) 504 may optionally query a Position Determining Entity (PDE) 505 per existing procedures to provide latitude/longitude (lat/lon) coordinates in addition to the Master Street Address Guide (MSAG) address. Note: In the event that the caller uses a cellular provider who employs a Mobile Positioning Center (MPC) 504 that does not have connectivity to the emergency 911 wireless call detector network, the Mobile Positioning Center (MPC) 504 processes the call normally and presumably provides an inaccurate latitude/longitude. The Mobile Positioning Center (MPC) 504 that is connected to the emergency 911 wireless call detector network stages the phone number and address, but does not receive the Automatic Location Identification (ALI) 509 query. After a given period of time, the staged record is deleted.

The emergency 911 wireless call detector network may optionally, but not necessarily, be connected to multiple Mobile Positioning Centers (MPCs) 504.

In accordance with the present invention, having an MSAG valid address, ALI data can now include ESN-specific responder data. Moreover, PSAP dispatchers no longer have to rely upon the emergency 911 wireless caller's self-reported location to correctly dispatch a suitable first responder.

The present invention has applicability to building construction or remodeling, with particularly interest by building owners, college campuses, University housing, multi-unit dwellings having effective 911 service for occupants, and/or residents of their buildings. Typical applicable buildings include office towers, underground garages, schools, apartment buildings, and other multi-level, multi-purpose or other large-scale construction, though it also has applicability to even residential homes, etc.

Building codes may be updated to include requirements for the installation of 911 wireless call detectors. The present invention contemplates and accommodates such updated technology. It also makes possible the ability and recognition that manufacturers of smoke detectors may upgrade otherwise conventional smoke detectors to now include 911 wireless call detectors into each smoke detector.

While the invention has been described with reference to the exemplary embodiments thereof, those skilled in the art will be able to make various modifications to the described embodiments of the invention without departing from the true spirit and scope of the invention.

What is claimed is:

1. An emergency wireless call detector, comprising:
a sniffer module to sniff an active emergency 911 call within a proximity of said emergency wireless call detector;
a programmable local location information module to store building-specific local location information relating to a physical location within a given building of an antenna of said emergency wireless call detector.

2. The emergency wireless call detector according to claim 1, wherein said building-specific local location information comprises:
a room number that said emergency wireless call detector is located in.

3. The emergency wireless call detector according to claim 2, wherein said building-specific local location information further comprises:
a floor number that said emergency wireless call detector is located in.

4. The emergency wireless call detector according to claim 2, wherein said building-specific local location information further comprises:
a master street address guide (MSAG) validated street address of said given building.

5. An emergency wireless call detector network, comprising:
a plurality of emergency wireless call detectors for mounting on separate floors of a given building;
a local 911 call server including a physical communication interface with said plurality of emergency wireless call detectors; and
a physical Internet Protocol (IP) interface in said local 911 call server to permit IP communication between said local 911 call server and a network-based 911 call server;
wherein said local 911 call server communicates building-specific location information from at least one of said plurality of emergency wireless call detectors to said network-based 911 call server.

6. A method of obtaining building-specific location information about a location of a calling wireless device within a given building, comprising:
receiving an emergency 911 call; and
matching building-specific location information from a detecting emergency 911 wireless call detector located within a building from which said emergency 911 call was initiated, with a wireless device making said emergency 911 call.

7. The method of obtaining building-specific location information about a location of a calling wireless device within a given building according to claim 6, further comprising:
staging said building-specific location information within a mobile positioning center (MPC).

8. The method of obtaining building-specific location information about a location of a calling wireless device within a given building according to claim 6, wherein said building-specific location information includes:
a master street address guide (MSAG)-validated address of said building from which said emergency 911 call was initiated.

9. The method of obtaining building-specific location information about a location of a calling wireless device within a given building according to claim 6, wherein said building-specific location information includes:
a floor number of said building from which said emergency 911 call was initiated.

10. The method of obtaining building-specific location information about a location of a calling wireless device within a given building according to claim 6, wherein said building-specific location information includes:
a room number of said building from which said emergency 911 call was initiated.
